(19) United States
(12) Patent Application Publication
(10) Pub. No.: US 2022/0083297 A1
(43) Pub. Date: Mar. 17, 2022

(54) JOB PROCESSING DEVICE AND JOB PROCESSING METHOD

(71) Applicant: SEIKO EPSON CORPORATION, Tokyo (JP)

(72) Inventor: Hiroyuki KURAMOTO, Shiojiri (JP)

(21) Appl. No.: 17/469,944

(22) Filed: Sep. 9, 2021

(30) Foreign Application Priority Data
Sep. 11, 2020 (JP) 2020-152847

(51) Int. Cl. G06F 3/12; H04N 1/00

(52) U.S. Cl. CPC G06F 3/1273; H04N 1/00411; G06F 3/1205; H04N 2201/0094; G06F 3/1293; H04N 1/00464; H04N 1/00474; G06F 3/1253

(57) ABSTRACT

A job processing device includes a user interface section, a communication section configured to perform communication with an external device, a job executing section configured to execute a job, and a display control section configured to display, on the user interface section, a history record indicating a history of an executed job. The display control section displays a history record of an internal job, which is a job input by operation on the user interface section, and a history record of an external job, which is a job input by operation on the external device, side by side in order of time.

The present application is based on, and claims priority from JP Application Serial Number 2020-152847, filed Sep. 11, 2020, the disclosure of which is hereby incorporated by reference herein in its entirety.

### BACKGROUND

### 1. Technical Field

The present disclosure relates to a job processing device and a job processing method.

### 2. Related Art

There has been known a function of displaying a history of an executed job in a multifunction peripheral or the like. For example, JP-A-2020-88440 (Patent Literature 1) states that, when an error occurs, a history of the error is displayed side by side with a history of a job.

Patent Literature 1 states that an execution history of an application executed by operating an operation section of an image processing device is displayed and history data is shared among a plurality of image processing devices. However, a history of a job input by operating a device other than a device having a history display function is not considered.

### SUMMARY

A job processing device according to an aspect of the present disclosure includes: a user interface section; a communication section configured to perform communication with an external device; a job executing section configured to execute a job; and a display control section configured to display, on the user interface section, a history record indicating a history of an executed job. The display control section displays a history record of an internal job, which is a job input by operation on the user interface section, and a history record of an external job, which is a job input by operation on the external device, side by side in order of time.

A job processing method according to an aspect of the present disclosure is a job processing method in a job processing device including a user interface section and a communication section configured to perform communication with an external device, the job processing method including: a job executing section executing a job; and a display control section displaying, on the user interface section, a history record of an internal job, which is a job input by operation on the user interface section, and a history record of an external job, which is a job input by operation on the external device, side by side in order of time.

### BRIEF DESCRIPTION OF THE DRAWINGS

FIG. 1 is a block diagram of a job processing device.

FIG. 2 is a diagram showing an example of a home screen.

FIG. 3 is a diagram showing an example of a WEB page for hot folder printing.

FIG. 4 is a diagram showing an example of an instruction screen displayed according to operation for a history record.

FIG. 5 is a diagram showing an example of an instruction screen displayed according to operation for a history record of the hot folder printing.

FIG. 6 is a flowchart of history record display processing.

FIG. 7 is a flowchart of re-execution processing.

FIG. 8 is a diagram showing an example of an upload printing screen.

### DESCRIPTION OF EXEMPLARY EMBODIMENTS

Embodiments of the present disclosure are explained according to order described below.

(1) Configuration of a job processing device
(2) History record display processing
(3) Re-execution processing
(4) Other embodiments

### (1) Configuration of a Job Processing Device

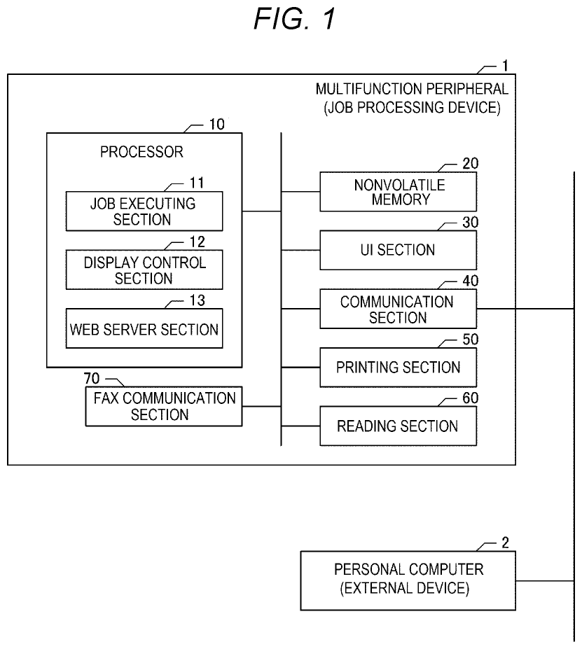

FIG. 1 is a block diagram showing the configuration of a multifunction peripheral 1 functioning as a job processing device according to an embodiment of the present disclosure. The multifunction peripheral 1 includes a processor 10, a nonvolatile memory 20, a user interface section 30 (hereinafter referred to as UI section 30), a communication section 40, a printing section 50, a reading section 60, and a FAX communication section 70. The processor 10 includes a CPU, a ROM, and a RAM not shown in FIG. 1 and can execute various programs recorded in the nonvolatile memory 20 and control the sections of the multifunction peripheral 1. The processor 10 may be configured by a single chip or may be configured by a plurality of chips. For example, an ASIC may be adopted instead of the CPU or the CPU and the ASIC may cooperate.

The UI section 30 includes a touch panel display. The touch panel display includes a display panel that displays various kinds of information based on control by the processor 10 and a touch detection panel laid on the display panel. The touch panel display detects touch operation by a human finger or the like. The touch panel display outputs information indicating the touch operation to the processor 10. The processor 10 acquires, based on the information, touch operation performed by a user.

The communication section 40 includes various communication interfaces for communicating with an external device by wire or radio. The communication section 40 includes an interface for communicating with various removable memories attached to the multifunction peripheral 1. In FIG. 1, a personal computer 2 (hereinafter referred to as PC 2) is illustrated as an example of the external device. Naturally, a plurality of external devices may be present.

In this embodiment, the communication section 40 includes an NFC communication section. The NFC communication section has a function of, when approaching an NFC tag at a default distance or less, communicating with the NFC tag and acquiring data recorded in a recording medium of the NFC tag.

In this embodiment, the printing section 50 includes an actuator, a sensor, a driving circuit, and mechanical components for executing printing on various printing media in various printing schemes such as an inkjet scheme or an electrophotographic scheme. The reading section 60 includes devices for reading a document placed on a document table glass or a document set on an ADF document tray, for example, a well-known color image sensor and a light source, and an actuator, a driving circuit, a sensor, and mechanical components for conveying the document.

The FAX communication section 70 includes a modem for performing FAX communication of image data indicating a document through a public switched telephone network or the like, a circuit for detecting and generating a control signal for transmitting and receiving the image data, and a circuit for encoding transmission data and decoding reception data.

The multifunction peripheral 1 includes a not-shown clocking circuit. The processor 10 can acquire present date and time from the clocking circuit.

In this embodiment, it is assumed that the multifunction peripheral 1 is a device installed in an office or the like and shared by a plurality of users. A user of the multifunction peripheral 1 carries an ID card. An identification number of the user is recorded in a recording medium of the ID card. When the user moves to the side of the multifunction peripheral 1 and uses the multifunction peripheral 1, the user holds the ID card over the NFC communication section. Then, the multifunction peripheral 1 acquires the identification number with the NFC communication section and determines whether the user is a user registered in an authentication information table explained below. When the user is a user registered in the authentication information table, the user can log in to the multifunction peripheral 1 and can use various functions of the multifunction peripheral 1 by logging in to the multifunction peripheral 1. The multifunction peripheral 1 includes a plurality of functions such as a copy function, a print function, a scan function, and a fax function.

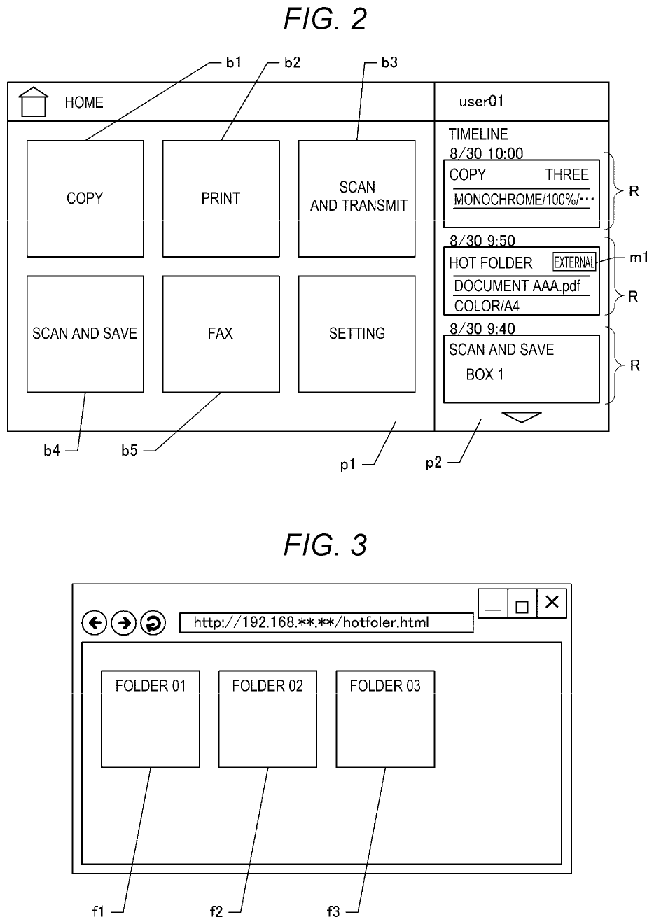

FIG. 2 is a diagram showing an example of a home screen displayed on the touch panel display of the UI section 30. The home screen includes a menu section p1 and a timeline section p2. The menu section p1 includes function selection buttons such as buttons b1, b2, b3, b4, and b5 corresponding to internal applications included in the multifunction peripheral 1. The functions explained above of the multifunction peripheral 1 are respectively allocated to the function selection buttons. The user can cause the multifunction peripheral 1 to display detailed screens of the functions associated with the function selection buttons by touching the function selection buttons. The timeline section p2 is a region where a history record R of a job executed in the multifunction peripheral 1 is displayed. Details of the timeline section p2 are explained below.

The processor 10 can execute a not-shown control program recorded in the nonvolatile memory 20. When the control program is executed, the processor 10 functions as a job executing section 11, a display control section 12, and a WEB server section 13. The WEB server section 13 is a program for causing the multifunction peripheral 1 to function as a WEB server. With the function of the WEB server section 13, the processor 10 can cause a display of the external device such as the PC 2 to display a WEB page of the multifunction peripheral 1 according to the HTTP. The functions explained above are realized by the processor 10 executing programs of the internal applications recorded in the nonvolatile memory 20.

When the user starts a browser in the PC 2 and sets a URL of a user authentication page of the WEB page provided by the multifunction peripheral 1, the page is displayed on the browser. When the user inputs and transmits, using a keyboard or the like of the PC 2, a user ID and a password for the user to use the multifunction peripheral 1, the processor 10 of the multifunction peripheral 1 determines whether a combination of the user ID and the password input by the user is a combination registered in the authentication information table. When the combination of the user ID and the password input by the user is the registered combination, the processor determines that user authentication is successful. Subsequently, when the processor 10 transmits image information of the WEB page of the multifunction peripheral 1 to the PC 2, the PC 2 displays a WEB site on the browser based on the image information.

In this embodiment, in the authentication information table, an identification number of the user recorded in an ID card carried by the user is recorded in association with the user ID and the password of the user. The authentication information table is recorded in, for example, the nonvolatile memory 20 of the multifunction peripheral 1. By referring to the authentication information table, the processor 10 of the multifunction peripheral 1 can determine whether a user who transmits a job from the PC 2 and a user who operates the UI section 30 of the multifunction peripheral 1 are the same. A configuration may be adopted in which the processor 10 performs user authentication in cooperation with another server (not shown) that manages user information and operation terminal information including information of the authentication information table.

The WEB page provided by the multifunction peripheral 1 includes a page functioning as a file reception screen for receiving a processing target file. In this embodiment, the processing target file is a printing target file. In this embodiment, the file reception screen is a page for hot folder printing. When the user of the PC 2 performs operation for displaying the page in the browser, the processor 10 transmits image information of the page for the hot folder printing to the PC 2. The PC 2 displays the page for the hot folder printing on the display based on the image information.

FIG. 3 is an example of the WEB page for the hot folder printing. As shown in FIG. 3, the page includes rectangular frames f1, f2, and f3 having folder numbers. The rectangular frames are objects respectively associated with hot folders (incorporated hot folders) secured in the nonvolatile memory 20 of the multifunction peripheral 1. In the multifunction peripheral 1, different combinations of parameters of print settings are respectively allocated to the hot folders. The print settings are, for example, conditions concerning a printing job such as a paper type, a paper size, a layout, duplex printing, and color/monochrome. In FIG. 3, a combination of adopted parameters may be displayed in the rectangular frames or near the rectangular frames. In this case, the user is capable of selecting, viewing the combination of the parameters, a hot folder that can perform printing in desired print setting.

When the user drags and drops a printing target file in a rectangular frame associated with a hot folder in which parameters of print settings are a desired combination, the PC 2 detects the operation and transmits the file from the PC 2 to the multifunction peripheral 1 together with a folder number of the hot folder associated with the rectangular frame and a user ID. When receiving these data via the communication section 40, the processor 10 of the multifunction peripheral 1 executes a printing job with a function of the job executing section 11 explained below.

The job executing section 11 is a function of executing a job. The job includes an internal job and an external job. The internal job is a job input by operation on the UI section 30 and is a job executed by an internal application. For example, when the user selects a copy button b1 of the menu section p1, the processor 10 executes an internal application of a copy function to thereby cause the UI section 30 to display a detailed screen of the copy function. Setting items of copy are displayed side by side on the detailed screen of the copy function. The user can change setting values (parameters) for each of the setting items. A start button is also included in the detailed screen of the copy function. When the user touches the start button, the processor 10 executes a copy job with the function of the job executing section 11. That is, the processor 10 reads a copy document with the reading section 60 and prints an image of the read document with the printing section 50.

Besides the copy (b1), for example, scan and transmit (b3) and scan and save (b4) also correspond to the internal job. Fax (b5) is classified into the internal job when a document is scanned and transmitted by fax in the multifunction peripheral 1 and is classified into an external job explained below when a transmission file is transmitted from the external device such as the PC 2 to the multifunction peripheral 1 and transmitted by fax. The buttons b1 to b5 corresponding to internal applications of these functions are displayed as a list in the menu section p1 of the home screen.

The external job is a job input by operation on the external device and includes a printing job for a file transmitted from the external device via a file reception screen indicated by image information displayed in the external device. Specifically, for example, the printing job by the hot folder explained above is the external job. When a folder number of the hot folder, a printing target file, and a user ID are received from the PC 2, the processor 10 causes the printing section 50 to print the printing target file based on parameters of print settings allocated to the hot folder indicated by the folder number.

The external job includes, besides the hot folder printing, a printing job transmitted through an application program or a driver program installed in the external device such as the PC 2. The printing job transmitted from the external device such as the PC 2 may be immediately executed after reception in the multifunction peripheral 1 or may be once accumulated in the nonvolatile memory 20 and executed in response to the user logging in to the multifunction peripheral 1 and operating a print button b2 of the UI section 30 to instruct printing. For example, when the print button b2 shown in the home screen in FIG. 2 is touched, the home screen transitions to a detailed screen of the print function. On the detailed screen of the print function, the user can select a printing job (a printing target file) accumulated in the nonvolatile memory 20 and executes printing. A printing target file transmitted from the external device such as the PC 2 and accumulated in the nonvolatile memory 20 is also finally printed in response to operation on the print button b2. However, since a printing job in this case is a job input by operation on the external device, the printing job is treated as the external job.

When finishing executing a job, the processor 10 records a history record indicating a history of the executed job in the nonvolatile memory 20 in association with a user ID. The history record includes a name of the job, used parameters, an execution completion date and time, distinction of the internal job and the external job, and a processing target file name of the job. In preparation for re-execution, the processor 10 saves an entity of a processing target file in the nonvolatile memory 20 in association with the history record.

The display control section 12 is a function of displaying a history record indicating a history of an executed job on the user interface section. The processor 10 displays, with the function of the display control section 12, a history record of an internal job and a history record of an external job side by side in order of time. When the user holds the ID card over the NFC communication section of the multifunction peripheral 1 and logs in to the multifunction peripheral 1, the processor 10 displays the home screen (see FIG. 2) on the UI section 30. At this time, the processor 10 acquires, with the function of the display control section 12, history records associated with a user ID of the logging-in user among history records recorded in the nonvolatile memory 20. The processor 10 displays, in the timeline section p2, the history records of the logging-in user, that is, n history records R in descending order of execution completion dates and times.

The number of history records displayed in one screen at a time can be different depending on a size and screen design of the touch panel display of the UI section 30 (in this embodiment, n=3 as shown in FIG. 2). The processor 10 displays the history records R further in the past in response to scroll operation performed in the timeline section p2 and determines n history records as display targets according to a scroll amount. In the timeline section p2, the history records R are displayed in the descending order of the execution completion dates and times from the top of the screen. The history records R include execution completion dates and times, names of jobs, parameters adopted for job execution, and processing target file names.

When both of a history record of an external job and a history record of an internal job are included in the n history records determined as the display targets in the timeline section p2, the processor 10 distinguishably displays the history records. In this embodiment, an identification mark ml indicating the external job is added to the history record of the external job. In this embodiment, in order to display a history record for each user of the multifunction peripheral 1, a history record of an internal job input according to an instruction of a user who operates the UI section 30 and logs in to the multifunction peripheral 1 and a history record of an external job input according to an instruction of a user who operates the external device are displayed side by side.

In this way, according to this embodiment, the user can visually recognize the history records of the external job in addition to the internal job in the UI section 30 of the multifunction peripheral 1. In this embodiment, since history records of jobs associated with the logging-in user are displayed, the user can visually recognize, in the UI section 30, history records of an internal job and an external job input by the user. Further, since the history record of the external job is displayed distinguishably from the history record of the internal job, the user can easily distinguish whether the history record is external job or the internal job in the timeline section p2.

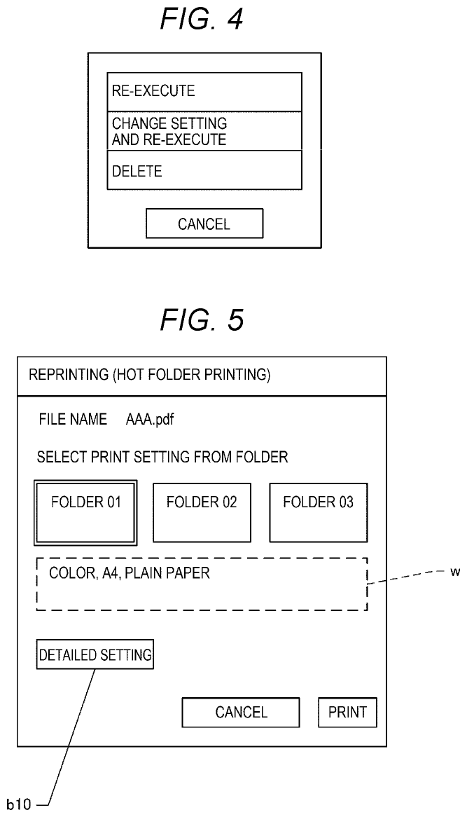

The processor 10 can receive operation for the history records R in the timeline section p2. When detecting touch operation for any one of the history records R in the timeline section p2, the processor 10 displays, on the UI section 30, an instruction screen for a job indicated by the history record R. For example, an instruction screen about a history record of a job (which may be either an internal job or an external job) other than hot folder printing explained below includes objects for receiving instructions such as “re-execute”, “change setting and re-execute”, and “delete”, as shown in FIG. 4. When the “re-execute” is selected, that is, when a re-execution instruction is given, the processor 10 applies the same parameters as parameters applied when the job indicated by the history record is executed and executes the job again. When the “change setting and re-execute” is selected, the processor 10 displays a detailed setting screen. In the detailed setting screen in this case, in setting values (parameters) of setting items, values indicated by history records are set as default values. However, the user can change the parameters to desired values in the detailed setting screen and instruct re-execution of a job. When the “delete” is selected, the processor 10 deletes a history record of a job being selected.

When operation for a history record of hot folder printing is performed, the processor 10 displays an instruction screen with the function of the display control section 12. In the instruction screen, the processor 10 informs print settings of a plurality of hot folders to be selectable as print settings used for reprinting of a file. FIG. 5 shows an example of an instruction screen displayed on the UI section 30 by the processor 10 when operation for the history record R of the hot folder printing is received. As shown in FIG. 5, hot folders provided by the multifunction peripheral 1 are presented as choices. A folder indicated by a double frame indicates that the folder is a hot folder being selected.

In a region w, parameters of print settings allocated to the hot folder being selected are displayed. When the user checks a print hot-folder-printed from the PC 2 and changes setting to reprint the print, the user can select print setting from the same choices in the multifunction peripheral 1 if all hot folders including other hot folders selectable when the hot folder printing is performed in the PC 2 are presented to the user. Naturally, when the user desires to re-execute the printing in a combination of parameters other than the presented hot folders, the user can display the detailed setting screen from a detailed setting button b10. The user can set the parameters of the print settings to desired values in the detailed setting screen.

Not only in such hot folder printing but also when the user inputs a printing job to the multifunction peripheral 1 from the PC 2 and moves to the side of the multifunction peripheral 1 and collects a print printed by the printing job, it could occur that the user desires to check a printing result, changes setting, and performs the printing again. According to this embodiment, since the history record of the external job is also displayed on the UI section 30 of the multifunction peripheral 1, in such a case, the user does not need to return to the PC 2 and preform operation for transmitting the printing job again. Accordingly, in the case of this embodiment, it is possible to improve convenience of the user compared with the related art.

### (2) History Record Display Processing

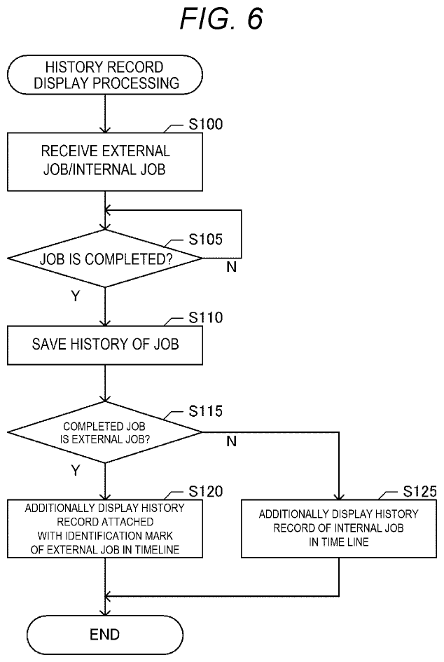

FIG. 6 is a flowchart showing history record display processing. The processing is started when the processor 10 acquires a job anew. When the history record display processing is started, the processor 10 receives, with the function of the job executing section 11, an external job or an internal job (step S100). That is, the processor 10 classifies the acquired job into the internal job or the external job and receives the job. The processor 10 receives, as the external job, a job input by operation on the external device and receives, as the internal job, a job input by operation on the UI section 30.

Subsequently, the processor 10 stays on standby with the function of the job executing section 11 until the job is completed (step S105). When determining in step S105 that the job is completed, the processor 10 saves a history of the job with the function of the job executing section 11 (step S110). That is, the processor 10 records a name of the executed job, parameters, an execution completion date and time, a user ID, and a processing target file name in the nonvolatile memory 20 in association with one another. The processor 10 saves an entity of a processing target file in the nonvolatile memory 20 in association with a history record.

Subsequently, the processor 10 determines, with the function of the display control section 12, whether the completed job is the external job (step S115). When determining that the completed job is the external job, the processor 10 additionally displays a history record attached with an identification mark for the external job in the timeline section p2 (step S120). When not determining in step S115 that the completed job is the external job, the processor 10 additionally displays, with the function of the display control section 12, a history record of the internal job in the timeline section p2 (step S125). That is, the processor 10 additionally displays the history record R of the completed job in a position indicating the latest history among history records displayed side by side in order of time (in this embodiment, at the top of the timeline section p2). When the completed job is the external job, the processor 10 adds the identification mark ml indicating the external job to the history record R as shown in FIG. 2.

### (3) Re-Execution Processing

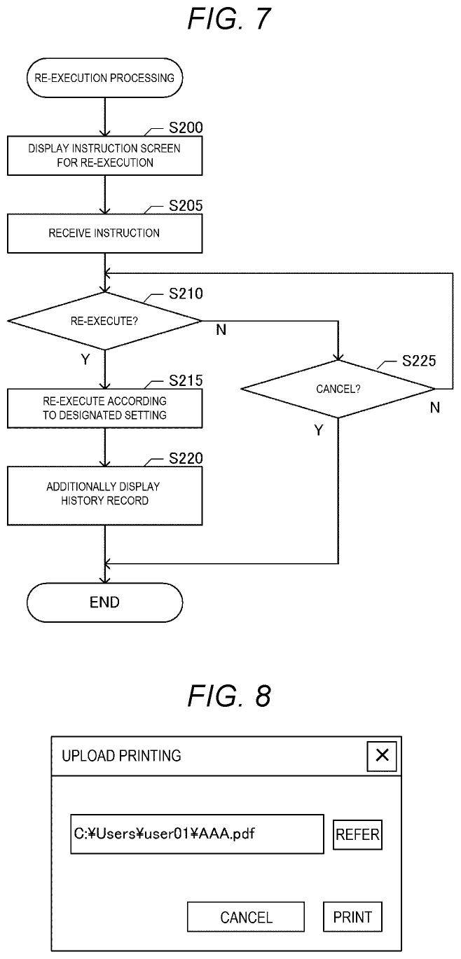

FIG. 7 is a flowchart showing re-execution processing. The processing is executed when operation for the history record R in the timeline section p2 is performed. When the re-execution processing is started, the processor 10 displays an instruction screen for re-execution with the function of the display control section 12 (step S200). For example, when an operated history record is a history record of a job other than hot folder printing, the processor 10 displays an instruction screen shown in FIG. 4. When the operated history record is a history record of the hot folder printing, the processor 10 displays an instruction screen shown in FIG. 5.

Subsequently, the processor 10 receives an instruction with the function of the display control section 12 (step S205). That is, the processor 10 receives, in the re-execution, an instruction for, for example, changing parameters. In the case of the hot folder printing, the processor 10 receives operation for selecting other hot folders and operation relating to detailed setting (see FIG. 5). It could occur that the re-execution is instructed without changing setting. In that case, step S205 is skipped.

Subsequently, the processor 10 determines, with the function of the display control section 12, whether the re-execution is instructed (step S210). That is, the processor 10 determines whether the re-execution is instructed after setting change (or without changing setting). When determining in step S210 that the re-execution is instructed, the processor 10 re-executes a job with the function of the job executing section 11 according to the instructed setting (step S215). That is, the processor 10 adopts the parameters after the change or adopts the parameters of the history record and re-executes a job indicated by the operated history record. The processor 10 displays, on the UI section 30, an object indicating progress of the job during the re-execution. After the execution is completed, the processor 10 records a name of the job, parameters, a user ID, execution completion time, and a processing target file name in the nonvolatile memory 20 as a history record of the executed job.

Subsequently, the processor 10 additionally displays the history record with the function of the display control section 12 (step S220). That is, the processor 10 erases the instruction screen from the UI section 30, displays the home screen, and additionally displays the history record of the re-executed job in the timeline section p2 in the home screen as the latest job.

When not determining in step S210 that the re-execution is instructed, the processor 10 determines whether the re-execution is cancelled (step S225). For example, when a cancel button is explicitly operated or when no operation is performed for a fixed time, the processor 10 determines that the re-execution is cancelled. When determining in step S225 that the re-execution is cancelled, the processor 10 ends the re-execution processing. When not determining in step S225 that the re-execution is cancelled, the processor 10 returns to the processing in step S210.

### (4) Other Embodiments

The embodiment explained above is an example for carrying out the present disclosure. Other various embodiments can be adopted. For example, the job processing device only has to be capable of executing both of the external job and the internal job. Various devices may be assumed other than the multifunction peripheral and the printer. The job processing device may be usable without user authentication or may be used through user authentication. As a premise, a plurality of users may use the job processing device. One user may use the job processing device.

The external device may be a portable device such as a smartphone or a tablet terminal or may not be the portable device. The job processing device and the external device may be present in the same LAN or may be communicable via the Internet or the like.

When the job processing device is used through user authentication, as a configuration for linking a user who instructs execution of an external job from the external device and a user who logs in to the job processing device, various configurations can be adopted other than the embodiment explained above. For example, in the case of printing through a driver program installed in the external device, if authentication information (a user ID and a password) of a user about the job processing device is once registered in the driver program, thereafter, the user may not input the authentication information in every printing. A user ID and a password of a user who logs in to the external device and a user ID and a password of the user in the job processing device may be managed in common or may be separately managed. When the user IDs and the passwords are managed in common, if the user logs in to the external device once, the user may not input the user ID and the password again when the user instructs printing to the WEB page of the multifunction peripheral 1 or the multifunction peripheral 1 via the driver program. For example, the user may log in to the job processing device by operating the UI section and inputting the user ID and the password.

When the job processing device is usable without user authentication, all external jobs and internal jobs executed in the job processing device may be displayed side by side in order of time irrespective of which user executes the jobs.

The external job only has to be a job input by operation on the external device. Besides the printing through the driver program installed in the PC and the printing through the hot folder incorporated in the job processing device, a job for uploading a processing target file to the job processing device or a server or the like other than the job processing device and causing the job processing device to print the file is also included in the external job. FIG. 8 is a screen example for selecting, as a printing target, a file recorded in the PC functioning as the external device and uploading the file to the job processing device. This upload printing may adopt a configuration in which the file is transmitted to the job processing device via the WEB server section of the job processing device or may adopt a configuration in which the file is delivered to the job processing device by another method.

The internal job only has to be a job input by operation on the UI section of the job processing device. For example, when the user operates the UI section of the job processing device to access another server and acquires a printing target file from the server and prints the file in the job processing device, this printing job may be treated as the internal job. That is, although the printing target file is received from the server, which is a type of the external device, since the job is input to the job processing device by the operation on the UI section of the job processing device, the job can be classified as the internal job.

The timeline section for displaying the history records side by side in order of time may be included in the home screen or may be included in a screen other than the home screen. For example, the history records may be displayed on a history display screen different from the home screen. The home screen is a screen displayed by operating a home button. When login is necessary for use, the home screen is, for example, a screen displayed for the first time after the login. The display control section only has to be able to display the history record of the internal job and the history record of the external job side by side in order of time. The display control section may be able to extract and display the internal job or extract and display the external job.

The display control section desirably distinguishably displays the history record of the external job and the history record of the internal job. An identification mark indicating the internal job may be added to the internal job and displayed. Besides adding the identification mark, colors of characters and backgrounds may be changed for the history record of the external job and the history record of the internal job. The external job and the internal job may be simply distinguishable by names of the jobs. Printing instructed to be executed using the driver program or the application program installed in the PC, the smartphone, or the tablet terminal and printing through the WEB server provided by the multifunction peripheral may be distinguishably displayed.

A name of the external job may include a type of a device at a job input source and a job input method. Specifically, for example, PC printing, smartphone printing, upload printing, and hot folder printing may be assumed. For example, an application program name used when printing is instructed may be included in a name of a job.

Further, the present disclosure is applicable as a program and a method executed by a computer as well. The system, the program, and the method explained above are realized as an independent device in some cases and are realized using components included in a plurality of devices in other cases and include various forms. The system, the program, and the method can be changed as appropriate, for example, a part thereof is software and a part thereof is hardware. Further, an invention is established as a recording medium for a program for controlling the system as well. It goes without saying that the recording medium for the program may be a magnetic recording medium or may be a semiconductor memory. All recording media to be developed in future can be considered completely the same.

What is claimed is:

1. A job processing device comprising:
a user interface section;
a communication section configured to perform communication with an external device;
a job executing section configured to execute a job; and
a display control section configured to display, on the user interface section, a history record indicating a history of executed jobs, wherein
the display control section displays a history record of an internal job, which is a job input by operation on the user interface section, and a history record of an external job, which is a job input by operation on the external device, side by side in order of time.

2. The job processing device according to claim 1, wherein the display control section distinguishably displays the history record of the external job and the history record of the internal job.

3. The job processing device according to claim 1, wherein the display control section displays an instruction screen for the external job on the user interface section when receiving operation for the history record of the external job, the instruction screen including an object for receiving a re-execution instruction for the external job.

4. The job processing device according to claim 1, wherein the display control section displays, side by side, the history record of the internal job input according to an instruction of a user who operates the user interface section and logs in and the history record of the external job input according to an instruction of the user who operates the external device.

5. The job processing device according to claim 1, further comprising a WEB server section configured to transmit image information for receiving a processing target file to the external device, wherein
the external job includes a printing job for the file transmitted from the external device via a file reception screen indicated by the image information displayed in the external device.

6. The job processing device according to claim 5, wherein the file reception screen is a screen including an object indicating a hot folder associated with print setting.

7. The job processing device according to claim 6, wherein
the file reception screen includes a plurality of objects respectively associated with a plurality of the hot folders,
different print settings are respectively allocated to the plurality of hot folders, and
the display control section displays an instruction screen when receiving operation for a history record of a printing job from a certain one of the hot folders and informs, on the instruction screen, print settings of the plurality of hot folders to be selectable as print settings used for reprinting of the file.

8. A job processing method in a job processing device including a user interface section and a communication section configured to perform communication with an external device, the job processing method comprising:
a job executing section executing a job; and
a display control section displaying, on the user interface section, a history record of an internal job, which is a job input by operation on the user interface section, and a history record of an external job, which is a job input by operation on the external device, side by side in order of time.
